(19) United States
(12) Patent Application Publication
(10) Pub. No.: US 2025/0157766 A1
(43) Pub. Date: May 15, 2025

(54) EXPLOSION-DRIVEN MULTI-BREAK CIRCUIT BREAKER

(71) Applicant: Hefei Institutes of Physical Science, CAS, Hefei (CN)

(72) Inventors: Hua Li, Hefei (CN); Zhiquan Song, Hefei (CN); Jifei Ye, Hefei (CN); Guanghong Wang, Hefei (CN); Zhenhan Li, Hefei (CN); Hang Su, Hefei (CN)

(21) Appl. No.: 18/802,546

(22) Filed: Aug. 13, 2024

(30) Foreign Application Priority Data
Nov. 14, 2023 (CN) 202311511788.8

(51) Int. Cl. H01H 39/00

(52) U.S. Cl. CPC H01H 39/00

(57) ABSTRACT

An explosion-driven multi-break circuit breaker is provided, including conductive plates, a detonating cord, an explosive column, a conductive cylinder, fracture zones, an explosion chamber, blocking rings, and supporting rods. The explosive column loaded with high explosives and a detonator is arranged in the explosion chamber filled with deionized water. The explosive column and the detonator are detonated using the detonating cord. The conductive plates are composed of an upper portion and a lower portion which are arranged at the outermost side of the circuit breaker in parallel. Both ends of the conductive cylinder are tightly connected to the conductive plates, and each of the blocking rings arranged at the periphery of the conductive cylinder is of a multi-break annular structure.

### CROSS-REFERENCE TO RELATED APPLICATION

This patent application claims the benefit and priority of Chinese Patent Application No. 202311511788.8 filed with the China National Intellectual Property Administration on Nov. 14, 2023, the disclosure of which is incorporated by reference herein in its entirety as part of the present application.

### TECHNICAL FIELD

The present disclosure relates to the field of high-voltage and high-current supply circuits, in particular to an explosion-driven multi-break circuit breaker, which has the characteristics of adjustable voltage level, high reliability and the like.

### BACKGROUND

Superconducting magnetic confinement fusion device is one of the important ways to solve human energy problems. During the operation of superconducting magnets in the superconducting magnetic confinement fusion device, the direct current can reach tens of thousands of amperes, with energy storage exceeding thousands of megajoules, and thus the high direct current must be cut off rapidly in the event of a quench fault. Explosive circuit breaker, served as a backup protection switch for a superconducting coil in the case of a quench fault, provides guarantee for the safe operation of the superconducting coil due to its characteristics of quick action and high reliability.

By using the characteristics of high explosive release power and fast breaking speed, an explosion-driven circuit breaker can limit a short-circuit current to a level far less than the expected short-circuit current, thus playing a role in current limiting protection. Through the design of a multi-break structure, voltage breaking ability at both ends of the switch can be maintained, and the number of breaks can be increased or decreased according to the actual demand for a breaking voltage, thus achieving the rapid development of series products. In both the Chinese patent applications CN113097026A and CN107993889, a multi-break structure is provided, but the multi-break structure is high in cost, small in capacity, low in breaking speed, and unable to flexibly adjust the breaking voltage in the circuit. Therefore, there is an urgent need to provide a multi-break breaking structure, in which the breaking voltage required in a circuit can be flexibly adjusted by adjusting the number of breaks.

### SUMMARY

In order to solve the technical problem above, an explosion-driven multi-break circuit breaker is provided, which has the advantages of rapid action, high reliability, and ability of flexibly adjusting a breaking voltage.

In order to achieve the objective above, the technical solution provided in the present disclosure is as follows:

An explosion-driven multi-break circuit breaker including conductive plates, a detonating cord, an explosive column, a conductive cylinder, fracture zones, an explosion chamber, blocking rings, and epoxy supporting rods. The explosive column is arranged in the explosion chamber, and the explosion chamber is filled with deionized water. The explosive column is filled with high explosives, and a high-speed detonator is arranged at an upper portion of the explosive column, and the explosive column and the detonator are detonated by an external detonating cord. The conductive plates are composed of an upper conductive plate and a lower conductive plate which are arranged at an outermost side of the circuit breaker in parallel. Both ends of the conductive cylinder are tightly connected to the conductive plates, and each of the blocking rings arranged at a periphery of the conductive cylinder is of a multi-break annular structure, and fixed between the upper conductive plate and the lower conductive plate by the epoxy supporting rods.

Further, the conductive cylinder is a thin-wall cylinder made of high conductivity material, multiple annular grooves are precut in an outer surface of the conductive cylinder as fracture zones, and both ends of the conductive cylinder are tightly connected to the conductive plates. The blocking rings are installed on the periphery of the conductive cylinder, fixed by the supporting rods at positions correspond to positions of the fracture zones of the conductive cylinder.

Further, the explosion chamber is an internal space enclosed by the upper conductive plate, the lower conductive plate, and the conductive cylinder. When the explosives are detonated, detonation waves are transmitted through the deionized water, so that the fracture zones of the conductive cylinder are fractured simultaneously. Electric arcs are occurred at the resultant breaks, and the electric arcs at the breaks are rapidly extinguished by a high-flow deionized water driven by denotation waves, so that voltage insulation is achieved.

Further, each of the blocking rings is of an annular insulating structure with high strength, made of fiberglass epoxy material, and cooperatively installed at the periphery of the conductive cylinder. The blocking rings are fixed between the upper conductive plate and the lower conductive plate by the supporting rods. When the explosives are detonated, the conductive cylinder is evenly fractured from the fracture zones, and turned outwards to be attached to surfaces of the blocking rings, so as to form multiple switching breaks, and level of the breaking voltage is flexibly adjusted by adjusting a number of the breaks.

Further, the explosives are installed along an axial direction of the conductive cylinder.

Further, a main current path of the circuit breaker is formed by the conductive plates and the conductive cylinder together. Without affecting an overall through-current, a current density of the conductive plates is reduced, a heating situation of the circuit breaker during steady through-current can be reduced, and the circuit breaker is protected.

Compared with the prior art, the present disclosure has the beneficial effects that:

According to the multi-break explosion-driven circuit breaker provided in the present disclosure, a high current can be rapidly broken in an extremely short time by explosive driving on the premise of meeting the through-current capacity of a high-voltage large circuit. The design of multiple breaks can provide high voltage breaking capacity at both ends of a switch, and the number of the breaks can be increased or decreased according to an actual demand for a breaking voltage, thus the rapid development of series products is achieved.

### BRIEF DESCRIPTION OF THE DRAWINGS

FIG. 1 is a front view of an explosion-driven multi-break circuit breaker according to the present disclosure;

FIG. 2 is a sectional view of an explosion-driven multi-break circuit breaker according to the present disclosure;

FIG. 3 is a sectional view of an explosion-driven multi-break circuit breaker according to the present disclosure after breaking.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

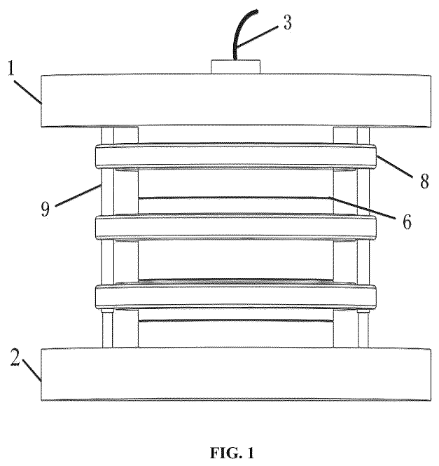

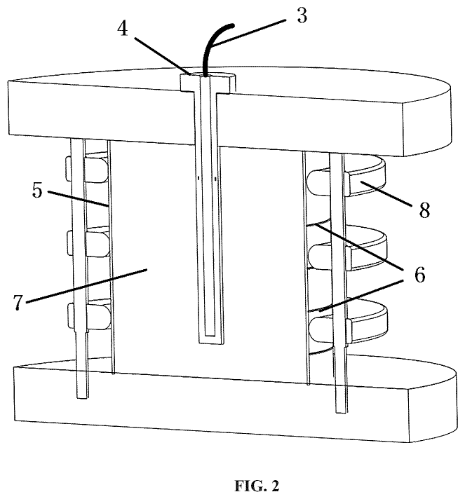

As shown in FIG. 1 and FIG. 2, an explosion-driven multi-break circuit breaker includes an upper conductive plate 1, a lower conductive plate 2, a detonating cord 3, an explosive column 4, a conductive cylinder 5, fracture zones 6, an explosion chamber 7, blocking rings 8, and epoxy supporting rods 9. The explosive column 4 is arranged in the explosion chamber 7, and the explosion chamber 7 is filled with deionized water. The explosive column 4 is filled with high explosives, and a high-speed detonator is arranged at an upper portion of the explosive column, and the explosive column and the high-speed detonator are detonated by an external detonating cord 3. The conductive plates are composed of an upper portion and a lower portion which are the upper conductive plate 1 and the lower conductive plate 2, and arranged at an outermost side of the circuit breaker in parallel. Both ends of the conductive cylinder 5 are tightly connected to the conductive plates, and each of blocking rings 8 arranged at a periphery of the conductive cylinder is of a multi-break annular structure, and fixed between the upper conductive plate 1 and the lower conductive plate 2 by the epoxy supporting rods 9. Preferably, there are three blocking rings 8 uniformly distributed on the epoxy supporting rods 9.

As shown in FIG. 1, the explosion-driven multi-break circuit breaker provided by the present disclosure is an important backup protection switch for a superconducting magnet and is connected in series in the entire superconducting magnet circuit. In a normal operating state, the explosion-driven multi-break circuit breaker needs to undergo a steady-state operating current for a long time. When the magnet is in quench, if a mechanical switch fails to break a superconducting circuit in time, the explosion-driven multi-break circuit breaker is about to be triggered to detonate, so as to break the superconducting circuit. Moreover, through the design of a multi-break structure, voltage breaking ability at both ends of the switch can be maintained, and the number of breaks can be increased or decreased according to the actual demand of a breaking voltage.

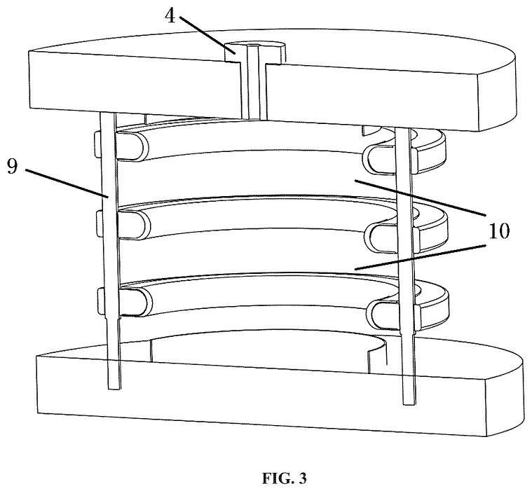

As shown in FIG. 2 and FIG. 3, after receiving a denotation instruction, the high explosives in the explosive column 4 are detonated with sub-second accuracy. The interior of the explosion chamber 7 is filled with the deionized water, and after the explosives are detonated, detonation waves are transmitted through the deionized water. As multiple annular grooves are precut in an outer surface of a cylinder of the explosion chamber 7 as fracture zones 6 in a horizontal direction, so that the fracture zones 6 of the conductive cylinder 5 are fractured simultaneously by the detonation waves. The conductive cylinder 5 is evenly fractured from the fracture zones 6, and turned outward to be attached to the surface of the blocking rings 8 to form multiple switching breaks 10. Electric arcs are occurred at the resultant switching breaks 10, and the electric arcs at the breaks are rapidly extinguished by high-flow deionized water driven by the denotation waves, so that voltage insulation is achieved. Finally, the rapid breaking of the high current is achieved in an extremely short time.

As shown in FIG. 2, the explosive column 4 is arranged in the explosion chamber 7, the explosive column 4 is filled with high explosives, and a high-speed detonator is arranged at an upper portion of the explosive column. The detonator and the explosive column 4 are detonated by an external detonating cord 3. RDX is generally used as explosives, and high detonation velocity of the RDX provides rapid pressure accumulation, thus achieving high synchronization in the fracture of gaps in the conductive cylinder 5, which means all breaks are fractured simultaneously. The deionized water is used as a transmission medium of the detonation waves in the explosion chamber 7, and the detonation waves after explosive detonation are transmitted to the conductive cylinder 5, and the deionized water is driven to be sprayed outside after the gaps are fractured, so that the electric arcs at the breaks are quickly extinguished.

As shown in FIG. 2, the conductive plates are made of copper material to form a main current path of an explosive switch and to provide the functions of installing and supporting. Furthermore, by accurately selecting the appropriate size, the current density can be effectively reduced, and the heating effect of the circuit breaker during operation can be reduced.

As shown in FIG. 2, the conductive cylinder 5 is a thin and easily broken conductive cylinder made of copper or aluminum material. Multiple annular grooves are precut in a horizontal direction of the conductive cylinder as gaps during the fracturing. Due to the limiting effect of the epoxy supporting rods installed at equal intervals, the conductive cylinder 5 is about to form rings at equal intervals after explosive forming. Both ends of the conductive cylinder are connected to the conductive portions, the explosives are installed in an axial direction of the conductive cylinder, and a certain gap is left among the conductive cylinder 5, the epoxy supporting rods 9, and the blocking rings 8.

As shown in FIG. 2, each blocking ring 8 is of an annular high-strength insulating structure, usually made of fiberglass epoxy material, and cooperatively installed at the periphery of the conductive cylinder 5. When the explosives are detonated, an interior space of the conductive cylinder 5 is rapidly filled with the deionized water. With the continuous development of the explosion process, a low-density gas generated by the explosive chemical reaction gradually occupies a middle portion of the chamber, and the water in the explosion chamber 7 is compressed outwards to interact with the conductive cylinder 5 together with shock waves and the blocking rings 8, such that weakened zones of the conductive cylinder 5 crack due to the fact, caused by stress concentration, that the plastic strain reaches a critical value of fracture strain, thus forming an annular shape to be attached to the blocking rings 8.

As shown in FIG. 3, the epoxy supporting rods 9 play a limiting role on the installed blocking rings 8, which ensure the integrity requirements of breaking and forming during breaking action, thus reducing the chipping and sharp serrations at edges of the breaks.

As shown in FIG. 3, through the design of multi-break structure, high voltage breaking capacity at both ends of the switch can be maintained, each break is broken by the impact of the detonation waves, with relatively uniform breaking intervals which together constitute a breaking distance. Therefore, the multiple breaks can be broken simultaneously well. The explosive waves caused by the explosion of explosives can cut off the weak parts of the conductive cylinder 5 transversely, thus forming multiple gaps at the breaks, and generating electric arcs. With the continuous pressure of the detonation shock waves, the gaps gradually become larger, and the electric arcs are stretched to form an electric arc voltage as high as several thousand volts. Due to the annular design of the multi-break, positive and negative electrodes are formed at upper and lower layers of the whole circumference to form multiple independent arc columns, which makes the electric arcs have a faster rate of change in the extinguishing process and easier to be extinguished. Therefore, the breaking speed of the circuit breaker is greatly improved.

The above description is only the specific embodiments of the present disclosure, but the scope of the protection of the present disclosure is not limited thereto. These embodiments are for illustration purposes only and are not intended to limit the scope of the present disclosure. The scope of the present disclosure is defined by the appended claims and their equivalents. Those skilled in the art can make various substitutions and modifications without departing from the scope of the present disclosure, which should fall within the scope of the present disclosure.

What is claimed is:

1. An explosion-driven multi-break circuit breaker, comprising:
conductive plates;
a detonating cord;
an explosive column;
a conductive cylinder;
fracture zones;
an explosion chamber;
blocking rings; and
epoxy supporting rods,
wherein the explosive column is arranged in the explosion chamber, and the explosion chamber is filled with deionized water,
wherein the explosive column is filled with high explosives, and a detonator is arranged at an upper portion of the explosive column, and the explosive column and the detonator are detonatable by the detonating cord,
wherein the conductive plates are composed of an upper conductive plate and a lower conductive plate which are arranged at an outermost side of the circuit breaker in parallel, and
wherein both ends of the conductive cylinder are tightly connected to the conductive plates, and each of the blocking rings arranged at a periphery of the conductive cylinder is of a multi-break annular structure, and fixed between the upper conductive plate and the lower conductive plate by the epoxy supporting rods.

2. The explosion-driven multi-break circuit breaker according to claim 1, wherein the conductive cylinder is a thin-wall cylinder made of high conductivity material, a plurality of annular grooves are precut on in outer surface of the conductive cylinder as fracture zones, and both ends of the conductive cylinder are connected to the conductive plates; and a plurality of blocking rings are installed on the periphery of the conductive cylinder, fixed by the epoxy supporting rods at positions correspond to positions of the fracture zones of the conductive cylinder.

3. The explosion-driven multi-break circuit breaker according to claim 1, wherein the explosion chamber is an internal space enclosed by the upper conductive plate, the lower conductive plate, and the conductive cylinder; when the explosives are detonated, detonation waves are transmitted through the deionized water, so that the fracture zones of the conductive cylinder are fractured simultaneously; and when electric arcs occur at resultant breaks, the electric arcs at the breaks are extinguished by a high-flow deionized water driven by denotation waves, so that voltage insulation is achieved.

4. The explosion-driven multi-break circuit breaker according to claim 1, wherein each of the blocking rings is of an annular insulating structure with high strength, made of fiberglass epoxy material, and cooperatively installed at the periphery of the conductive cylinder; the blocking rings are fixed between the upper conductive plate and the lower conductive plate by the epoxy supporting rods; and when the explosives are detonated, the conductive cylinder is evenly fractured from the fracture zones, and turned outwards to be attached to surfaces of the blocking rings, so as to form a plurality of switching breaks, and level of the breaking voltage is adjusted by adjusting a number of the breaks.

5. The explosion-driven multi-break circuit breaker according to claim 1, wherein the explosives are installed along an axial direction of the conductive cylinder.

6. The explosion-driven multi-break circuit breaker according to claim 1, wherein a main current path of the circuit breaker is formed by the conductive plates and the conductive cylinder together, without affecting an overall through-current, a current density of the conductive plates is reduced, a heating situation of the circuit breaker during steady through-current is capable of being reduced, and the circuit breaker is protected.
